(19) United States
(12) Patent Application Publication
(10) Pub. No.: US 2025/0313677 A1
(43) Pub. Date: Oct. 9, 2025

(54) Polycarbonate as a Chemical Blowing Agent

(71) Applicant: Zephyros, Inc., Romeo, MI (US)

(72) Inventors: Michael Czaplicki, Romeo, MI (US); Keith Madaus, Romeo, MI (US); David Kosal, Romeo, MI (US); Garrett Moody, Romeo, MI (US); Robert Roggers, Romeo, MI (US)

(21) Appl. No.: 18/708,708

(22) PCT Filed: Nov. 18, 2022
(86) PCT No.: PCT/US2022/050392

§ 371 Date: May 9, 2024

Related U.S. Application Data
(60) Provisional application No. 63/280,893, filed on Nov. 18, 2021.

(51) Int. Cl. C08J 9/08; C08G 59/24; C08G 59/40; C08J 3/12; C08J 9/10; C08J 11/28

(52) U.S. Cl. CPC C08J 9/08; C08G 59/245; C08G 59/4021; C08J 3/12; C08J 9/103; C08J 11/28; C08J 2203/02; C08J 2203/184; C08J 2207/02; C08J 2363/00; C08J 2369/00

(57) ABSTRACT

A method comprising combining polycarbonate thermoplastic with a decomposition initiator to decompose polycarbonate, heating the polycarbonate thermoplastic and decomposition initiator to a temperature between 120° C. and 250° C. for the release of carbon dioxide, and wherein the polycarbonate thermoplastic and decomposition initiator are combined with one or more additional components for forming a heat activated material that foams as a result of the release of carbon dioxide.

### TECHNICAL FIELD

This invention relates to the use of polycarbonate polymers and/or oligomers in combination with other ingredients (i.e., decomposition activator) that enable the decomposition of polycarbonate at above ambient temperatures but below the melting point temperature of polycarbonate to release carbon dioxide gas for use as a chemical blowing agent.

### BACKGROUND

Chemical blowing or foaming agents are commonly used in the production of foamed articles. In foams that are produced via a heat activation step, chemical foaming agents are typically compounded into a formulated product that will be activated in a subsequent step when the composition is exposed to an elevated temperature above the compounding step. Often, the foaming agent is in the form of a particle that when exposed to elevated temperatures, decomposes to release a gas. Nitrogen and carbon dioxide are common principal gases that are released, although in many cases, additional gases are released as well. Physical foaming agents such as volatile liquids and plastic microspheres containing a solvent are often used as foaming agents as well.

While industrially useful, solid particulate foaming agents have a number of potential deficiencies depending on the specific utilization of the foaming agent. Among the deficiencies are interaction and reactivity with the formulated product that it is placed into, flammability prior to compounding, which complicates storage and shipping, odor imparted to the foamed product, and health concerns related to exposure to the foaming agent (with azodicarbonamide as an example).

One consequence encountered with chemical foaming agents such as azodicarbonamide (Tradename Celogen AZ) or benzenesulphonyl hydrazide (Tradename Celogen OT) is that they can react with other constituents within a formulated product to reduce the shelf stability of the product prior to heat activation. This can compromise the suitability of the product, particularly when the products might be exposed to elevated temperatures during secondary processing, shipping, or storage (i.e., shelf-life reduction). The next effect typically is reduction of foaming percentage and often reduced adhesion to a substrate if the foamed article is expected to have adhesive attributes.

As such, there exists a need and a desire for chemical blowing agents suitable for products that are intended to foam as a result of heat activation that are stable when compounded into the formulation, are non-flammable and safe to handle, and do not produce decomposition products or by-products that create undesirable odors.

### SUMMARY OF THE INVENTION

The present teachings meet one or more of the above needs by the improved methods described herein.

In a first aspect the teachings herein provide for a method for forming a heat activated material that foams as a result of the release of carbon dioxide, said method comprising combining polycarbonate thermoplastic (e.g., thermoplastic polycarbonate) with a decomposition initiator to decompose polycarbonate; and heating the polycarbonate thermoplastic and decomposition initiator to a temperature between 120° C. and 200° C. for the release of carbon dioxide; wherein the polycarbonate thermoplastic and decomposition initiator are combined with one or more additional components.

In another aspect, the teachings herein provide for a composition comprising a polycarbonate thermoplastic, a decomposition initiator to decompose polycarbonate, an optional solvent in which the polycarbonate is dissolved and one or more additional components for forming a heat-activated adhesive. The polycarbonate thermoplastic and decomposition initiator are adapted to release carbon dioxide upon heating the composition to a temperature between 120° C. and 250° C.

The decomposition initiator may be an amine. The decomposition initiator may be a dicyandiamide or dicyandiamide. The decomposition initiator may be a compound bearing an urea functional group, which preferably may be a substituted urea. The decomposition initiator may be a reaction product of bisphenol A epoxy and monoethanolamine. The decomposition initiator may be a metal halide. The decomposition initiator may be a blocked isocyanate. The decomposition initiator may be an ammonium salt. The decomposition initiator may be a metal phosphate ester salt. The decomposition initiator may be a metal stearate salt. The decomposition initiator may be a metal carbonate or metal hydroxide. The decomposition initiator may be a metal acetylacetonate. The decomposition initiator may be a titanate complex. The decomposition initiator may be a metal triflate. The decomposition initiator may be an organophilic phyllosilicate. The polycarbonate may be dissolved in a suitable solvent to form a dissolution product. The solvent may be capable of subsequently reacting into the polymeric composition, The solvent may be a liquid epoxy. The solvent may be solid epoxy. The solvent may be a combination of liquid and solid epoxy. The solvent may be a polycarbonate polyol. The solvent may be a polycaprolactone polyol. The solvent may be an organic solvent including but not limited to acetone, methyl ethyl ketone, diethyl ketone, toluene or xylene.

In another aspect, the teachings herein provide for a composition comprising, relative to the total weight of the composition, at least 10% by weight epoxy resin; at least 0.5% by weight dicyandiamide; at least 0.5% by weight substituted urea; and from about 2-10% by weight polycarbonate thermoplastic.

The weight ratio of dicyandiamide to a compound bearing an urea functional group, preferably substituted urea, may be within the range of from 1:0.5 to 1:1.5. The polycarbonate and decomposition initiator may be micro-pulverized.

### BRIEF DESCRIPTION OF THE DRAWINGS

FIG. 1 displays a graph showing amounts of CO₂ evolution in various combinations of components.

FIGS. 2A and 2B show the chemical structures and their relative levels of electron density and steric hindrance.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 63/280,893, filed on Nov. 18, 2021. The contents of that application are incorporated by reference herein in their entirety for all purposes.

The basis of the teachings herein is the understanding that polymeric or oligomeric polycarbonate (e.g., polycarbonate thermoplastic, thermoplastic polycarbonate), when combined with certain additional ingredients, can initiate decomposition of polycarbonate at a temperature well below its normal decomposition temperature (more than 400° C.) to release carbon dioxide to perform as a foaming agent. To stimulate polycarbonate decomposition at a reduced temperature, at least one decomposition promoting agent may be utilized. The decomposition promoting agent may be utilized as part of a compounded product that may typically be composed of one or more polymers combined with additional additives.

Examples of suitable decomposition promoting agents include but are not limited to amines and nitrogen containing compound. Examples of amines and nitrogen containing compounds include tertiary amines, imidazoles, amine adducts, triazoles, amides, urea, and ammonium derivatives. Examples of other suitable decomposition promoting agents include metal chlorides, blocked isocyanates, metal phosphate ester salts, metal stearate salts, metal carbonates, metal hydroxides, metal acetylacetonates, titanate complexes, metal triflates, organophilic phyllosilicates, and other Lewis acids. The choice and quantity of decomposition agent may determine the decomposition temperature range of the polycarbonate and the amount of carbon dioxide decomposition product.

The softening point of a polycarbonate polymer is typically in the range of 150° C. to 170° C. depending on molecular weight. Unless expressly stated otherwise, the softening point is preferably the VICAT softening point determined in accordance with ASTM D 1525 Rate B (50 N). Therefore, if there is a desire to incorporate the polycarbonate into a heat activated material that is active at or below these temperatures, it may be necessary to dilute the polycarbonate to enable incorporation by preventing curing of the compounded polymeric composition during compounding. As one non-limiting example, to incorporate polycarbonate into epoxide functional heat active systems, the polycarbonate may be dissolved into a bisphenol A based liquid epoxy as a solvent. Since both polycarbonate and bisphenol A have a monomer in common, there is good solubility of polycarbonate in standard liquid epoxy resin. Such a solvent, containing reactive functionality, has the advantage of having the capability of reacting into the polymeric matrix during heat activation. Other epoxides containing organic aromaticity can serve as suitable solvents as well, such as bisphenol F epoxy resins. It may be possible to produce a dissolution product ranging from a viscous liquid to a non-fusable solid at 23° C., depending on the amount of liquid epoxy resin used to perform the dissolution. The solid dissolution product can be in the form of pellets, granules, or powder. The dissolution product can also be in the form of a liquid. Other epoxy resins can also be used as solvents such as bisphenol F liquid resin or even solid epoxy resin. A combination of epoxy resins can be used as the solvent to optimize the physical state of the dissolution product.

Another method for incorporating the polycarbonate polymer involves a step of micro-pulverizing or cryogrinding the polycarbonate and the decomposition agent. A resulting powder may then be mixed together to form a foaming agent. This foaming agent can be added to a heat activated material to impart foaming capability. A challenge with this approach can be obtaining sufficiently small polycarbonate particles due to the impact resistant nature of polycarbonate.

As described above, the dissolution of polycarbonate using epoxy as a solvent has particular utility in epoxy-based adhesives or foams. However, it is also possible that the same dissolution product could be combined with one or more suitable decomposition promoting agents to cause foaming of non-epoxy-based materials. Similarly, the micro-pulverized polycarbonate powder combined with a decomposition agent could be used to foam non-epoxide functional materials.

The choice of epoxy as a solvent is particularly useful for epoxy-based thermoset materials as described above. However, it is envisioned that solvents other than epoxy may also be utilized to dissolve the polycarbonate material. An example of a solvent other than an epoxy is a polycarbonate polyol (Tradename Eternacoll PH200D). A polycarbonate polymer may be dissolved in the polycarbonate polyol to form a dissolution product. Depending upon the amount of polyol used, the dissolution product can be in the form of a viscous liquid or a non-fusable solid. Less preferably, an organic solvent could also be used to solvate polycarbonate and later be removed through evaporation. Known organic solvents may include acetone, methyl ethyl ketone, diethyl ketone, toluene or xylene.

When polycarbonate, either in the form of a solid or liquid dissolution product or in the form of a powder from micro-pulverization, is compounded into a formulated heat activated composition and combined with a decomposition agent, it is then possible to create foamed articles upon exposure to elevated temperatures.

The teachings herein make advantageous use of polycarbonate as a chemical blowing agent in formulated compositions via polycarbonate decomposition and associated release of carbon dioxide. On its own, polycarbonate is a stable engineering polymer. However, when combined with other ingredients, particularly bases, then the decomposition temperature can be reduced significantly. Importantly, it can be reduced to a temperature range that is useful for the creation of gas for heat activated polymeric compositions. This temperature range is typically between 140° C. to 250° C. for foamed adhesive applications. Typical automotive adhesive applications are cured at 140° C. to 250° C. This includes the temperature range that exists to cure the electrodeposition coating (e-coat) used for corrosion prevention of steel or other metals in the automotive industry, as an example.

As mentioned above, the use of polycarbonate as a chemical foaming agent in an adhesive formulation involves the release of the carbon dioxide gas. This release rate can be matched to the cure kinetics of the adhesive if the adhesive is a thermosetting material. For instance, a typical epoxy adhesive utilized in automotive manufacture includes a combination of epoxy resins cured with a latent amine such as dicyandiamide (for example, Amicure CG-325G). On its own, dicyandiamide does not react enough to fully cure the epoxy resin over the entire temperature range of 140° C. and 250° C. currently in use by most automobile manufacturers. This may be due in part to the latency of the dicyandiamide, but also related to the fact that there are thick metal sections that need to be joined in an automobile that can prevent the transfer of thermal energy needed to provide sufficient cure of the composition. For this reason, curing agent activators/accelerators are often used to reduce the necessary curing temperature of the dicyandiamide curing agent by increasing dicyandiamide solubility in the epoxy matrix and thereby providing for a faster reaction.

It is possible that choosing the correct particle size and type of curing agent and curing agent accelerator can assist in optimizing the cure kinetics. In addition, the correct combination of curing agents and curing agent accelerators should be selected so that the carbon dioxide from the polycarbonate decomposition can sufficiently foam the adhesive. If the selected combination of curatives causes the material to build molecular weight too quickly, the carbon dioxide may be unable to foam the material to the desired extent. On the other hand, if the selected combination of curatives causes the epoxy resin to cure too slowly, carbon dioxide gas may diffuse out of the adhesive, producing less foaming than desired and potentially lead to collapse of the foamed article.

It has been found that amines and amine derivatives are particularly suited to reduce the decomposition temperature of polycarbonate. However, the amine or nitrogen containing amine derivatives chosen to reduce the decomposition temperature of the polycarbonate should be selected so as not interfere negatively with the curing mechanisms in the adhesive, particularly the product latency. For example, ethanolamine has been found to be a proficient decomposition agent for polycarbonate. However, the use of ethanolamine in a latent, heat activated epoxy system would be expected to react during mixing or compounding if the material being mixed has epoxide functionality. To address this deficiency, it is possible that the ethanolamine could be encapsulated with a shell that would melt or otherwise degrade at the appropriate temperature thus delivering the ethanolamine for promoting decomposition of the polycarbonate.

Based upon the foregoing, the basic composition chosen for the polycarbonate decomposition may be chosen in such a way that it can be added to a typical heat activated adhesive without reacting during mixing or reducing shelf life unacceptably or affecting other adhesive attributes negatively such as adhesion, adhesion durability, or mechanical properties. Particularly useful amines and nitrogen containing compounds that can be used in a latent epoxy adhesive to reduce the decomposition temperature of the polycarbonate are dicyandiamide, compounds bearing an urea functional group, preferably substituted urea compounds such as Omicure U52M (aromatic substituted urea, 4,4′-methylene bis(phenyl dimethyl urea)) from Huntsman Corporation, amine adducts such as Ancamine 2441 (modified polyamine) and the reaction product of monoethanolamine or other mono-primary or di-secondary amines with epoxides.

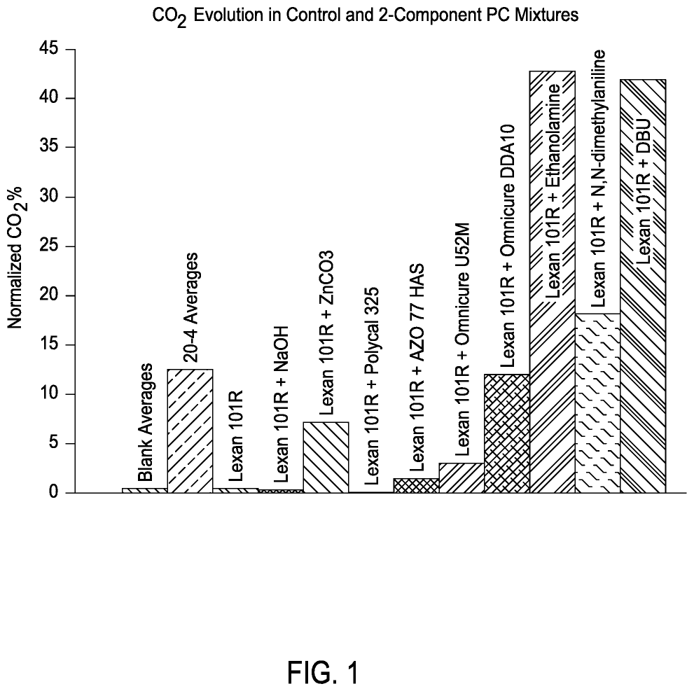

To test the efficacy of decomposition promoting agents, multiple combinations of decomposition agents are added to polycarbonate and heated at 165° C. Only the polycarbonate and activator are utilized as opposed to a formulated composition. Gas Chromatography-Mass Spectrometry (GC-MS) techniques are used to determine the amount of carbon dioxide (CO₂) liberated (see results at FIG. 1). The polycarbonate utilized is Lexan 101R from Sabic. As evident in FIG. 1, when the polycarbonate is heated to 165° C. without use of a decomposition agent, there is no CO₂ liberated. Whereas, when ethanolamine is added to the polycarbonate and heated at 165° C., the CO₂/O₂ content is over 40%.

In FIG. 1, the CO₂ amount is listed as a ratio of carbon dioxide or CO₂ to oxygen or O₂. Gas Chromatography-Mass Spectrometry (GC-MS) is performed under normal atmospheric conditions, and since the O₂ level is stable under the atmospheric conditions, it is used to normalize the CO₂ quantity so that differences in sample size or injection volumes do not influence the result.

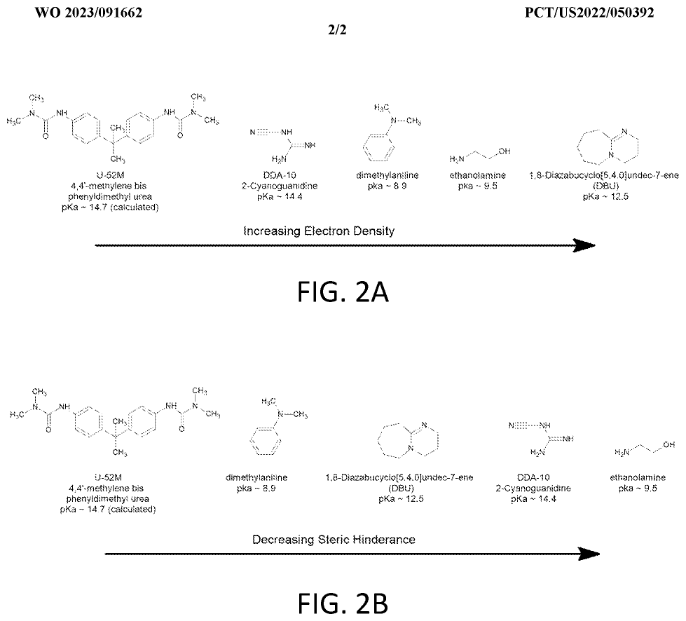

FIG. 2 shows the chemical structure of several of the decomposition initiators listed in FIG. 1. It can be seen that as the electron density increases and the steric hinderance decreases, the initiator tends to become efficient at reducing the decomposition temperature of polycarbonate to liberate CO₂.

The result in FIG. 1 labeled “20-4” is a fully-formulated heat-activated, foaming adhesive. Formulation 20-4 contains polycarbonate polymer along with amine containing ingredients used to polymerize the epoxide groups in the adhesive. Since the 20-4 formulation does not contain a typical foaming agent such as azodicarbonamide, it would not be expected to foam. It is therefore deduced that amine containing compounds can reduce the decomposition temperature of polycarbonate polymer. It is further determined that two amine containing compounds used in the 20-4 formulation to cure the epoxy resin, DDA 10 and Omicure U-52M were useful polycarbonate decomposition agents for releasing CO₂. The result in FIG. 1 labeled Lexan 101R+Omicure U-52M+DDA10 shows that DDA 10 (dicyandiamide) which is an epoxy curative, and Omicure U-52M (substituted urea), which is an accelerator for DDA 10, cause a similar amount of CO₂/O₂ to be released from the decomposition of the polycarbonate polymer, as compared to the 20-4 formulation. Therefore, not only was it surprising that amine or nitrogen containing compounds can decompose polycarbonate well below its softening point to release CO₂, but it was also surprising and useful to find that two amine containing ingredients typically used to crosslink epoxy thermosets are particularly proficient as polycarbonate decomposition agents.

Since both the compound bearing an urea functional group, preferably substituted urea and dicyandiamide are useful to crosslink an epoxy adhesive and it has been shown in FIG. 1 that each of these can decompose polycarbonate to release CO₂, testing is performed to understand the effect of concentration of the amine containing constituents related to CO₂ generation. Table 1 shows a model formulation selected to help study the effect of dicyandiamide and urea on decomposition of polycarbonate polymer to release CO₂. The model formulation uses a 100% stoichiometric ratio of reactive hydrogen to epoxide groups. In this case, stoichiometry (or stoichiometric ratio) refers to the ratio of curing agent (DDA 50) to epoxide functionality needed to react with all epoxide functionality present. When 100% stoichiometry is indicated, this means that enough curing agent is present to crosslink 100% of the epoxide groups. Likewise, when 80% stoichiometry is indicated, this means there is enough curing agent to consume 80% of the epoxide groups (leaving 20% of the epoxide rings unreacted or to homopolymerize), and so on.

TABLE 1
Batch with 100% Stoichiometry

| Ingredient | | |
|---|---|---|
| Polycarbonate | | Weight |
| Dissolution (PcD) | Description | (grams) |
| 30.15% Entec Hylex | Polycarbonate polymer | 3.62 |
| P1010L1 | | |
| 36.85% Kukdo YDF-170 | Bisphenol F liquid epoxy | 4.42* |
| 33.00% DER 667 | Solid epoxy | 3.96* |
| L-SA01 | Reaction product of CTBN | 25.22* |
| | and solid epoxy | |
| DER 331 | Bisphenol A liquid epoxy | 13.81* |
| Type 1, 80:20 MB | Masterbatch of fiber and | 3.2* |
| | solid epoxy | |
| HuberCarb Q325 | Filler | 22.41 |
| DDA 50 | Dicyandiamide curative | 2.54* |
| SP-AD0052 | Urea cure accelerator | 0.82 |
| TOTAL (grams) | | 80.00 |

*= ingredients involved in stoichiometric ratio calculations

Based on the model formulation in Table 1, testing is performed using different stoichiometric ratios of dicyandiamide to the epoxy containing ingredients in the formulation. The ratios of polycarbonate dissolution (PcD) to dicyandiamide from those formulations, based on the model formulation, using varying stoichiometric ratios of curing agent, are then tested for CO₂ evolution using GC-MS. Only dicyandiamide is used as a decomposition promoter in Table 2 below. In Table 3, both dicyandiamide and urea were used. The ratio of polycarbonate to urea was held constant in Table 3 below.

As described previously, since the polycarbonate cannot be compounded into a formulation typically due to its high softening point, a dissolution is made by dissolving the polycarbonate into a suitable solvent. In this case, a liquid epoxy is used as the solvent which will subsequently become part of the cured composition. Therefore, it is a reactive solvent. In this example, the dissolution consists of 45% by weight polycarbonate dissolved into 55% by weight bisphenol F based epoxy resin, although other ratios can be considered. In the temperature range of 140° C. to 250° C., the dissolution containing polycarbonate and epoxy mixture does not decompose to release CO₂ on its own. However, with the addition of decomposition promoting agents, with amines or nitrogen containing bases being especially effective, CO₂ is generated. The CO₂ that is generated can be used to foam adhesives or sealants.

TABLE 2

| Stoichometric Concentration of DDA 50 | 100% | 90% | 80% | 70% | 60% | 50% | 40% | 30% | 20% | 10% | 0% |
|---|---|---|---|---|---|---|---|---|---|---|---|
| Polycarbonate Dissolution (PcD) | 75.90 | 77.78 | 79.74 | 81.82 | 84.00 | 86.30 | 88.73 | 91.30 | 94.03 | 96.92 | 100.00 |
| 45% Entec Hylex P1010L1 | | | | | | | | | | | |
| 55% Kukdo YDF-170 | | | | | | | | | | | |
| DDA 50 | 24.10 | 22.22 | 20.26 | 18.18 | 16.00 | 13.70 | 11.27 | 8.70 | 5.97 | 3.08 | |
| Total (grams) | 100.00 | 100.00 | 100.00 | 100.00 | 100.00 | 100.00 | 100.00 | 100.00 | 100.00 | 100.00 | 100.00 |
| CO₂/0₂ Ratio at 300° F. | 0.070 | 0.066 | 0.054 | 0.056 | 0.047 | 0.047 | 0.034 | 0.047 | 0.360 | 0.036 | 0.029 |
| CO₂/0₂ Ratio at 350° F. | 0.233 | 0.309 | 0.393 | 0.367 | 0.347 | 0.363 | 0.367 | | 0.420 | 0.084 | 0.044 |
| CO₂/0₂ Ratio at 375° F. | | 0.444 | 0.579 | 0.360 | 0.393 | 0.461 | 0.466 | 0.506 | 0.629 | 0.328 | 0.073 |

TABLE 3

| Stoichometric Concentration of DDA 50 | 100% | 90% | 80% | 70% | 60% | 50% | 40% | 30% | 20% | 10% | 0% |
|---|---|---|---|---|---|---|---|---|---|---|---|
| Polycarbonate Dissolution (PcD) | 70.42 | 72.03 | 73.72 | 75.49 | 77.34 | 79.29 | 81.33 | 83.49 | 85.76 | 88.16 | 100.00 |
| 45% Entec Hylex P1010L1 | | | | | | | | | | | |
| 55% Kukdo YDF-170 | | | | | | | | | | | |
| DDA 50 | 22.36 | 20.58 | 18.72 | 16.78 | 14.73 | 12.59 | 10.33 | 7.95 | 5.45 | 2.80 | |
| SP-AD0052 | 7.22 | 7.39 | 7.56 | 7.73 | 7.93 | 8.12 | 8.34 | 8.56 | 8.79 | 9.04 | |
| Total (grams) | 100.00 | 100.00 | 100.00 | 100.00 | 100.00 | 100.00 | 100.00 | 100.00 | 100.00 | 100.00 | 100.00 |
| CO₂/0₂ Ratio at 300° F. | 0.712 | 0.900 | 0.802 | 0.962 | 1.126 | 0.742 | 0.872 | 1.008 | 1.157 | 1.737 | 0.029 |
| CO₂/0₂ Ratio at 350° F. | 0.923 | 0.947 | 1.282 | 1.515 | 2.140 | 1.428 | 1.467 | 1.619 | 1.841 | 2.894 | 0.044 |
| CO₂/0₂ Ratio at 375° F. | 1.169 | 0.804 | 1.335 | 1.408 | 2.915 | 1.519 | 1.782 | 3.330 | 2.309 | 3.279 | 0.073 |

Table 2 above shows the CO₂ release due to the decomposition of polycarbonate polymer in the presence of the dicyandiamide curing agent. Regardless of the stoichiometric ratio used in the model formulation, the amount of CO₂ release was relatively low, ranging in ratio from about 0.03 to 0.60 depending upon the temperature used for decomposition and the stoichiometric ratio used. Increasing the testing temperature increases the amount of CO₂ generated.

Table 3 above shows the CO₂ release due to the presence of dicyandiamide curing agent in combination with a urea accelerator. The amount of CO₂ generation with the addition of urea is significantly higher than with the dicyandiamide alone. The amount of CO₂ generated with both dicyandiamide and urea present ranges in ratio from about 0.70 to 3.3 depending on test temperature and stoichiometric ratio. The amount of CO₂ generation increased with increasing test temperature. The column in Table 2 and Table 3 labeled as 0% does not include an amine-containing curing agent compound to assist in decomposing the polycarbonate polymer. The amount of CO₂ generation is very low when no amine-containing compound is present, showing that dicyandiamide and urea in combination may act as decomposition initiators for polycarbonate polymers. Table 3 demonstrates that the use of urea and dicyandiamide together is more effective at decomposing polycarbonate to release CO₂ gas than the use of dicyandiamide alone.

Table 4 and Table 5 show the CO₂ liberated when L-TE01-35E and L-TE01-30A are used as polycarbonate decomposition promotion agents. L-TE01-35E is a polymer produced from the reaction of a di-epoxide and monoethanolamine with an excess of epoxy such that it is terminated with epoxide groups. L-TE01-30A is the reaction product of a di-epoxide and monoethanolamine with excess amine such that it is amine terminated. These are typically thermoplastic compositions that can be useful in formulated, heat-activated materials that are capable of structural bonding and reinforcement. Specifically, these thermoplastic materials can increase the strain to failure and peel strength of structural foam materials. There are tertiary amines along the backbone of the reaction product. These amines are presumed to reduce the decomposition temperature of polycarbonate and thereby facilitate CO₂ production. The results in Table 4 and Table 5 show that for each polymer there is CO₂ generated from the polycarbonate dissolution. Recall the polycarbonate dissolution (PcD) in this case consists of 45% by weight polycarbonate polymer dissolved in 55% by weight bisphenol A (or optionally bisphenol F) liquid epoxy. As the concentration of L-TE01-35E is increased relative to the PcD, the amount of CO₂ generation reaches a maximum ratio of 7.4 at a composition of 67/33 L-TE01-35E/PcD. This is likely due to the fact that for higher relative ratios of TE01-35E to PcD, the percentage of polycarbonate has been reduced to a point that there is not enough polycarbonate to decompose thereby resulting in reduced total gas production. A similar phenomenon is observed when the amine terminated product is used. As the concentration of L-TE01-30A is increased relative to the PcD, the amount of CO₂ generation reaches a maximum ratio at 6.7 at a composition of 67/33 L-TE01-35E/PcD. However, utility limits for concentrations of either L-TE01-35E or L-TE01-30A may exist in an adhesive formulation.

TABLE 4

| Run | 1 | 2 | 3 | 4 | 5 | 6 | 7 | 8 | 9 | 10 | 11 |
|---|---|---|---|---|---|---|---|---|---|---|---|
| L-TE01-35E | 15.97 | 8.30 | 15.97 | 22.50 | 33.00 | 40.00 | 50.00 | 60.00 | 67.00 | 75.00 | 80.00 |
| Polycarbonate Dissolution (PcD) | 84.03 | 91.70 | 84.03 | 77.50 | 67.00 | 60.00 | 50.00 | 40.00 | 33.00 | 25.00 | 20.00 |
| Total Weight % | 100.00 | 100.00 | 100.00 | 100.00 | 100.00 | 100.00 | 100.00 | 100.00 | 100.00 | 100.00 | 100.00 |
| CO₂/0₂ Ratio at 300° F. | 0.73 | | | | | | | | | | |
| CO₂/0₂ Ratio at 350° F. | 2.84 | 1.88 | 2.70 | 3.55 | 4.30 | 4.96 | 4.77 | 4.81 | 7.40 | 7.36 | 4.15 |
| CO₂/0₂ Ratio at 400° F. | 3.41 | | | | | | | | | | |

TABLE 5

| Run | 1 | 2 | 3 | 4 | 5 | 6 | 7 | 8 | 9 | 10 | 11 |
|---|---|---|---|---|---|---|---|---|---|---|---|
| L-TE01-30A | 15.97 | 8.30 | 15.97 | 22.50 | 33.00 | 40.00 | 50.00 | 60.00 | 67.00 | 75.00 | 80.00 |
| Polycarbonate Dissolution (PcD) | 84.03 | 91.70 | 84.03 | 77.50 | 67.00 | 60.00 | 50.00 | 40.00 | 33.00 | 25.00 | 20.00 |
| Total Weight % | 100.00 | 100.00 | 100.00 | 100.00 | 100.00 | 100.00 | 100.00 | 100.00 | 100.00 | 100.00 | 100.00 |
| CO₂/0₂ Ratio at 300° F. | 1.36 | | | | | | | | | | |
| CO₂/0₂ Ratio at 350° F. | 2.61 | 1.39 | 2.72 | 4.05 | 3.99 | 4.52 | 4.53 | 4.42 | 6.71 | 6.44 | 4.54 |
| CO₂/0₂ Ratio at 400° F. | 4.34 | | | | | | | | | | |

Table 6 shows additional polycarbonate decomposition agents based on metal salts and complexes, amine derivatives, blocked isocyanate or silicate. Two particularly useful polycarbonate decomposition agents for one component heat-activated adhesives shown in Table 6 are Curezol 2MAOK and Ancamine 2441. These are epoxy curatives capable of producing a shelf-stable adhesive. When Curezol 2MAOK is mixed with the polycarbonate dissolution (PcD), a ratio of about 3.4 CO₂/O₂ gas is liberated at 350° F. When Ancamine 2441 is mixed with the polycarbonate dissolution, a ratio of about 2.2 CO₂/O₂ gas is liberated. These compare favorably to dicyandiamide which releases about 0.3 when tested under comparable conditions.

TABLE 6

| Run | 1 | 2 | 3 | 4 | 6 | 6 | 7 | 8 | 9 | 10 | 11 | 12 |
|---|---|---|---|---|---|---|---|---|---|---|---|---|
| 45:55 Polycarbonate | 100.00 | 84.03 | 84.03 | 84.03 | 84.03 | 84.03 | 84.03 | 84.03 | 84.03 | 84.03 | 84.03 | 84.03 |
| Dissolution | | | | | | | | | | | | |
| Blocked Isocyanate | | 15.97 | | | | | | | | | | |
| (2-methylimidazole) | | | | | | | | | | | | |
| Tetramethyl | | | 15.97 | | | | | | | | | |
| Ammonium | | | | | | | | | | | | |
| Acetate | | | | | | | | | | | | |
| Potassium | | | | 15.97 | | | | | | | | |
| Carbonate | | | | | | | | | | | | |
| Ancamine K54 | | | | | 15.97 | | | | | | | |
| Imidazole (2MAOK) | | | | | | 15.97 | | | | | | |
| Adjicure PN-23 | | | | | | | 15.97 | | | | | |
| Benzotriazole | | | | | | | | 15.97 | | | | |
| SnCl₂ | | | | | | | | | 15.97 | | | |
| Ancamine 2441 | | | | | | | | | | 15.97 | | |
| FeCl₃ | | | | | | | | | | | 15.97 | |
| Sodium Hydroxide | | | | | | | | | | | | 15.97 |
| Lanthanum Triflate | | | | | | | | | | | | |
| Zinc Stearate | | | | | | | | | | | | |
| Garamite-1958 | | | | | | | | | | | | |
| Copper | | | | | | | | | | | | |
| Acetylacetonate | | | | | | | | | | | | |
| Aminomethyl | | | | | | | | | | | | |
| Propanediol | | | | | | | | | | | | |
| Piperazine | | | | | | | | | | | | |
| KR 134SP | | | | | | | | | | | | |
| (Oxyacetate Chelate | | | | | | | | | | | | |
| Titanate) | | | | | | | | | | | | |
| Titanium Phosphate | | | | | | | | | | | | |
| Ester Salt Complex | | | | | | | | | | | | |
| Magnesium | | | | | | | | | | | | |
| Hydroxide | | | | | | | | | | | | |
| AlCl₃ | | | | | | | | | | | | |
| Epotec YDM 441 | | | | | | | | | | | | |
| Scandium | | | | | | | | | | | | |
| Triflate | | | | | | | | | | | | |
| Total Weight % | 100.00 | 100.00 | 100.00 | 100.00 | 100.00 | 100.0 | 100.00 | 100.00 | 100.00 | 100.00 | 100.00 | 100.00 |
| CO₂/0₂ | 0.044 | 5.174 | 5.061 | 4.029 | 3.979 | 3.424 | 2.843 | 2.733 | 2.278 | 2.195 | 1.949 | 1.544 |
| Ratio at 350° F. | | | | | | | | | | | | |
| Run | 13 | 14 | 15 | 16 | 17 | 18 | 19 | 20 | 21 | 22 | 23 | 24 |
| 45:55 Polycarbonate | 84.03 | 84.03 | 84.03 | 84.0 | 84.03 | 84.03 | 84.03 | 84.03 | 84.03 | 84.03 | 84.03 | 84.03 |
| Dissolution | | | | | | | | | | | | |
| Blocked Isocyanate | | | | | | | | | | | | |
| (2-methylimidazole) | | | | | | | | | | | | |
| Tetramethyl | | | | | | | | | | | | |
| Ammonium | | | | | | | | | | | | |
| Acetate | | | | | | | | | | | | |
| Potassium | | | | | | | | | | | | |
| Carbonate | | | | | | | | | | | | |
| Ancamine K54 | | | | | | | | | | | | |
| Imidazole (2MAOK) | | | | | | | | | | | | |
| Adjicure PN-23 | | | | | | | | | | | | |
| Benzotriazole | | | | | | | | | | | | |
| SnCl₂ | | | | | | | | | | | | |
| Ancamine 2441 | | | | | | | | | | | | |
| FeCl₃ | | | | | | | | | | | | |
| Sodium Hydroxide | | | | | | | | | | | | |
| Lanthanum Triflate | 15.97 | | | | | | | | | | | |
| Zinc Stearate | | 15.97 | | | | | | | | | | |
| Garamite-1958 | | | 15.97 | | | | | | | | | |
| Copper | | | | 15.97 | | | | | | | | |
| Acetylacetonate | | | | | | | | | | | | |
| Aminomethyl | | | | | 15.97 | | | | | | | |
| Propanediol | | | | | | | | | | | | |
| Piperazine | | | | | | 15.97 | | | | | | |
| KR 134SP | | | | | | | 15.97 | | | | | |
| (Oxyacetate Chelate | | | | | | | | | | | | |
| Titanate) | | | | | | | | | | | | |
| Titanium Phosphate | | | | | | | | 15.97 | | | | |
| Ester Salt Complex | | | | | | | | | | | | |
| Magnesium | | | | | | | | | 15.97 | | | |
| Hydroxide | | | | | | | | | | | | |
| AlCl₃ | | | | | | | | | | 15.97 | | |
| Epotec YDM 441 | | | | | | | | | | | 15.97 | |
| Scandium | | | | | | | | | | | | 15.97 |
| Triflate | | | | | | | | | | | | |
| Total Weight % | 100.00 | 100.00 | 100.00 | 100.00 | 100.00 | 100.00 | 100.00 | 100.0 | 100.00 | 100.00 | 100.00 | 100.00 |
| CO₂/0₂ | 1.171 | 1.016 | 0.99 | 0.498 | 0.464 | 0.290 | 0.233 | 0.220 | 0.169 | 0.121 | 0.120 | 0.102 |
| Ratio at 350° F. | | | | | | | | | | | | |

The polycarbonate that was used as the basis for the invention is a bisphenol A based polycarbonate with a melt index of 10 g/10 min (as measured in accordance with ASTM D1238) when measured at 300° C. and 1.2 kg weight. However, it is contemplated that polycarbonate polymers with a lower or higher melt index may also be used. The polycarbonate used in the above experiments comes directly from the polymer manufacturer. However, recycled polycarbonate can also be used to generate CO₂ to impart foaming as well. It is also possible that other carbonate monomers or polymers can be used to release carbon dioxide. Propylene carbonate, ethylene carbonate, poly(alkylene carbonate) and other organic carbonates can be used to release CO₂ for foaming.

As stated previously, due to the high softening or melting point of the polycarbonate, it is typically not possible to compound this with other ingredients in a heat activated product without activating the formulated product during compounding. Therefore, it is necessary to reduce the softening point of the polycarbonate. Liquid epoxy may be used as a solvent to dissolve the polycarbonate, thus making a dissolution product. Solid epoxy could be used as well although it may be a less effective solvent. This dissolution product can then be introduced along with other ingredients to make a foaming thermoset adhesive.

Improved results are obtained when using a bisphenol F epoxy, as the solvent has lower viscosity than typical bisphenol A epoxy, and thus provides faster solubilization and a potentially higher solute concentration. 36.85% bisphenol F epoxy (Kukdo YDF-170) is heated to 191° C. in a stirred reactor using a Cowles blade. Over a period of 75 minutes, 30.15% polycarbonate (Entec P1010L1) is added to the stirred reactor. After addition of all the polycarbonate, the blend is allowed to mix for an additional hour to dissolve all of the polycarbonate. Finally, 33.00% solid epoxy (DER 667) is added over a period of 20 minutes. This was an optional step since DER 667 was not always utilized in the dissolution, but the 45:55 polycarbonate: bisphenol F liquid epoxy ratio by weight was maintained throughout the work. The dissolution is then removed from the reactor, cooled and size reduced into granules or powder. While solid material is produced for these experiments, the material could be a semi-solid or liquid as well depending upon the preferred physical state, as dictated by relative percentages of solvent and solute, for incorporation via compounding. The physical state upon cooling is controlled by solvent/solute relative ratios. The addition of the solid epoxy may be added for the purpose of making a solid dissolution product that does not agglomerate at room temperature or slightly elevated temperatures such as 40° C.

The above dissolution product is then incorporated with additional components to develop a heat activated, foaming epoxy adhesive. Table 7 below shows sample formulations for a foaming thermosetting epoxy adhesive with a typical chemical foaming agent such as azodicarbonamide, with the newly developed polycarbonate solution and with a combination of the two chemical foaming ingredients.

TABLE 7

| Ingredient | 1 | 2 | 3 | 4 | 5 |
|---|---|---|---|---|---|
| TMEP70ASP | 3.50 | 3.50 | 3.50 | 3.50 | 3.50 |
| Kukdo YD-017 | 20.00 | 17.50 | 16.96 | 14.79 | 13.29 |
| Kukdo KD-242G | 5.99 | 1.64 | | | |
| Garamite 1958 | | | | 1.00 | 2.00 |
| PVB | 12.00 | 12.00 | 12.00 | 12.00 | 11.00 |
| Kane Ace MX-257 | 22.25 | 22.25 | 22.25 | 22.25 | 22.25 |
| Epoxonic Adduct | 2.50 | 2.50 | 2.50 | 2.50 | 2.50 |
| DER 331 | 2.92 | 2.92 | 2.92 | 2.92 | 2.92 |
| Type 4 Aramid MB | 3.75 | 3.75 | 3.75 | 3.75 | 3.75 |
| Vansil HR2000 | 23.31 | 23.31 | 23.31 | 22.31 | 19.31 |
| Halox SZP-391 | | | | | 3.00 |
| DDA 50 | 1.40 | 1.40 | 1.40 | 1.40 | 1.40 |
| UR400 | 1.05 | 1.05 | 1.05 | 1.05 | 1.05 |
| Celogen 754A | 1.30 | 0.65 | 0.33 | | |
| PcD Blowing Agent | | 7.50 | 10.00 | 12.50 | 14.00 |
| Pigment | 0.03 | 0.03 | 0.03 | 0.03 | 0.03 |
| Total Weight % | 100.00 | 100.00 | 100.00 | 100.00 | 100.00 |

Table 8 shows key properties of the respective formulated materials from Table 7. As shown from the results, it is possible to formulate an adhesive using polycarbonate as the sole foaming ingredient. The current foaming agent, azodicarbonamide, has amine groups in the molecule:

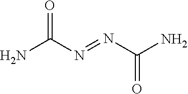

It is believed that these amine groups, particularly the 4 active hydrogens (with 2 primary), can reduce the latency of the formulated epoxy adhesive. That is, the formulated material has a reduced shelf life prior to heat activation. It is possible that the use of polycarbonate as a foaming agent will produce a more latent formulated product. Evidence of such is shown below in Table 8. The retention of volume expansion, of material that is exposed to elevated temperature (43° C. and 54° C.) compared to the expansion of material held at 23° C., is higher for the compositions that contain more polycarbonate and less azodicarbonamide. The temperatures of 43° C. and 54° C. were chosen as representative temperatures that could be encountered during shipping and/or storage in warm climates.

TABLE 8

| Property | 1 | 2 | 3 | 4 | 5 |
|---|---|---|---|---|---|
| Expansion (%) | 351 | 265 | 243 | 212 | 252 |
| Expansion (%) after RT for 7 D, (Retention %) | 316 (90%) | 265 (100%) | 236 (97%) | 197 (93%) | 208 (83%) |
| Expansion Retention after 3 D @ 43° C. | 72% | 91% | 94% | 88% | 65% |
| Expansion Retention after 3 D @ 54° C. | 34% | 63% | 75% | 86% | 127% |
| Vertical Rise (mm) | 11.3 | 10.4 | 10.4 | 9.6 | 10.8 |
| Lapshear Strength (psi) | 573 | 593 | 490 | 556 | 433 |
| T-peel Strength (N/mm) | 4.50 | 4.81 | 5.26 | 5.18 | 4.87 |
| Tensile Modulus (MPa) | 803 | 778 | 850 | 1092 | 749 |
| Tensile Strength (MPa) | 7.3 | 7.2 | 8.6 | | 7.6 |
| Elongation (%) | 1.32 | 1.23 | 1.37 | 1.74 | 1.53 |
| Modulus @ 23° C. (MPa) | 903 | 855 | 940 | 1065 | 937 |
| Modulus @ 80° C. (MPa) | 536 | 522 | 557 | 574 | 549 |
| Modulus Retention @ 80° C. (%) | 59 | 61 | 59 | 54 | 59 |
| Tg by Softening point (° C.) | 95 | 100 | 101 | 96 | 99 |

The fact that the volume expansion retention is reduced for the materials containing more azodicarbonamide supports the premise that the amine groups reduce the latency of the adhesive and are a significant source of shelf-life reduction. It is possible that the amine groups can cause the epoxy to react, and in doing so, advance in molecular weight, thus increasing the viscosity of the adhesive to produce less expansion with the same amount of gas evolution while simultaneously reducing the ability of the composition to develop adhesion to a substrate. Note that the effect of foaming percentage reduction is typically more pronounced at the higher aging temperature (54° C. as shown at Table 8).

Tables 9-10 show a sample formulation and corresponding volume expansion and lap shear results. The results show that it is possible to obtain good foaming with polycarbonate as the foaming agent, and lap shear strength at a range of cure temperatures and times. The adhesive foams well and has good lap shear performance even at a cure temperature as low as 120° C.

TABLE 9

| Ingredient | Batch 162 |
|---|---|
| SP-SA24 | 12.00 |
| TMEP70ASP | 14.00 |
| L-TE01-35E | 2.50 |
| PVB | 1.50 |
| Kukdo YD-017 | 2.74 |
| KaneAce MX-257 | 13.09 |
| Epoxonic Adduct | 3.00 |
| Kukdo YD-128 | 1.56 |
| Aramid/KD-214C MB | 3.69 |
| Garamite 1958 | 2.50 |
| Halox SZP-391 | 3.50 |
| Vansil HR2000 | 22.79 |
| Polycarbonate Dissolution | 15.00 |
| DDA 50 | 1.00 |
| UR400 | 1.03 |
| Pigment | 0.10 |
| Total | 100.00 |

TABLE 10
Batch 162

| Cure Schedule | Volume Expansion | Lap Shear Strength (psi) |
|---|---|---|
| 110° C./40 min | 120 | 197 |
| 120° C./40 min | 135 | 348 |
| 130° C./40 min | 164 | 648 |
| 140° C./40 min | 179 | 665 |
| 150° C./30 min | 182 | 689 |
| 160° C./30 min | 179 | 717 |

Regarding the experimental results shown at Tables 8 and 10, testing proceeds as follows: Volume expansion and uncured/cured density are measured utilizing a metal coupon measuring 25×100×0.75 mm (cold rolled steel). The uncured sample size is 12.7×63.5×2.7 mm. The curing schedule is at 325° F. for 30 minutes. Lap shear strength (ASTM D1002) is measured utilizing a metal coupon measuring 25×100×1.5 mm (EG-60 coated). The uncured sample size is 25×25×2.75 mm with a 3 mm bond line and an overlap of 25 mm. The cure schedule is 325° F. for 30 minutes and test speed is 2.00 inches/minute. T-Peel is measured utilizing metal coupons measuring 25×100×0.75 mm (EG-60 coated). Coupons are bent at 25 mm to a 90 degree angle. leaving 25 mm for grip area and 75 mm as material bonding area. The uncured sample size is 25×75×1.50 mm with a 1.5 mm (glass bead) bond line. The cure schedule is 325° F. for 30 minutes and the test speed is 254 mm/minute. Tensile strength and tensile strain to failure (ASTM D638) are measured using a cured sample thickness of 3 mm and a sample size/shape of JIS 6301-1 Dogbone. The cure schedule is 325° F. for 30 minutes, and testing utilizes a 50 mm extensometer at 5.0 mm/minute. The glass transition temperature is measured utilizing ASTM D7028-07.

The teachings described here within have shown that a polycarbonate thermoplastic can be decomposed well before its decomposition temperature by use of a decomposition agent (especially an amine) to generate carbon dioxide to be used as a chemical foaming agent. Also described is the development of a dissolution using epoxy as a solvent to dissolve the polycarbonate in order to reduce the softening point such that it can easily be compounded with other ingredients used in a heat-activated material. Lastly, what is described is the use of the polycarbonate inside of a dissolution as an ingredient in an epoxy adhesive formulation to produce a material capable of foaming with good mechanical performance.

The polycarbonates described herein may be utilized in a variety of formulations. Such formulations may include epoxy-based materials and may also include additional components including toughening agents, flexibilizers, curing agents and accelerators and various reinforcement components and other additives.

It is possible that the formulations described herein include at least one type of polymeric particle. As used herein, like with any other ingredients of the present teachings, the term “polymeric particle” can include one or more types of polymeric particles. Various types of polymeric particles may be employed in the practice of the present teachings and often include one or more elastomers. It is generally preferable for the polymeric particles to be at least 4%, more typically at least 7%, even more typically at least 10%, still more typically at least 13% and even still more typically at least 16% by weight of the formulations and also preferable for the polymeric particle to be less than 90%, more typically less than 40% an even more typically less than 30% by weight of the formulations, although higher or lower amounts may be used in particular embodiments.

The polymeric particle may include one or more core/shell polymers which may be pre-dispersed in an epoxy. The process for forming the core shell materials in a liquid epoxy avoids agglomeration of the core shell particles as may be common with “dry” core shell polymeric particles (e.g., agglomeration may occur during the drying process). An example of products made by this process may be described in one or more of U.S. Pat. Nos. 3,984,497; 4,096,202; 4,034,013; 3,944,631; 4,306,040; 4,495,324; 4,304,709; and 4,536,436. The polymeric particles may be formed through an emulsion polymerization process. This process may include the addition of a solvent with the resin. As a result of incompatibility between the resin/solvent and water, the water settles out of the material as the core shell particles move into the resin, resulting in reduced agglomeration. Alternatively, a high-speed dispersion can be effective at de-agglomerating core/shell materials. However, a surfactant may remain post spray drying or coagulating the core/shell material. This residual surfactant may be detrimental for the material's resistance to environmental exposure conditions that involve water such as salt spray and humidity. Materials not exposed to the environmental exposure conditions would typically not show a difference between dry core shell and liquid core shell masterbatch provided that there is sufficient de-agglomeration of the dry material.

Examples of useful core-shell graft copolymers may be those where hard containing compounds, such as styrene, acrylonitrile or methyl methacrylate, may be grafted onto a core made from polymers of soft or elastomeric compounds such as butadiene or butyl acrylate. U.S. Pat. No. 3,985,703, describes useful core-shell polymers, the cores of which are made from butyl acrylate but can be based on ethyl isobutyl, 2-ethylhexyl or other alkyl acrylates or mixtures thereof. The shell portion may be polymerized from methyl acrylates such as methyl methacrylate and optionally other alkyl acrylates and methacrylates, such as ethyl, butyl, or mixtures thereof acrylates or methacrylates as these materials are compatible with the phenoxy resin and any epoxy resins that are used in the formulation. Up to 40 percent by weight or more of the shell monomers may be styrene, vinyl acetate, vinyl chloride, and the like. Examples of core-shell graft copolymers include, but are not limited to, “MBS” (methacrylate-butadiene-styrene) polymers, which are made by polymerizing methyl methacrylate in the presence of polybutadiene or a polybutadiene copolymer rubber.

Examples of useful core/shell polymers include but are not limited to those sold under the tradename, Kane Ace, commercially available from Kaneka. Particularly preferred grades of Kane Ace core/shell are sold under the designations MX-257 and M711 or Clear Strength E-950 available from Arkema. The core/shell polymer may be from about 5% to about 30% by weight of the formulation.

The formulation may include a flexibilizer. The use of the term flexibilizer can relate to a single flexibilizer or a combination of multiple different flexibilizers. Although other flexibilizers may be employed, preferred flexibilizers include polymers that are amine modified, epoxy modified, or both. These polymers can include thermoplastics, thermosets or thermosettables, elastomers, combinations thereof or the like. These polymers may be modified with aromatic or non-aromatic epoxy and/or may be modified with bisphenol-F type, bisphenol-A type, combinations thereof or other type epoxy. Examples of preferred flexibilizer are epoxidized polysulfides sold under the tradenames EPS-350 and EPS-80, commercially available from Akzo Nobel.

Phenol-containing molecules such as the flexibilizer Rez-Cure EP 1820 (available from Innovative Resin Systems) are one possible material that may be utilized. An example of another preferred flexibilizer is an epoxy-dimer acid elastomer sold under the tradenames HYPOX DA323, commercially available from Huntsman. An example of other preferred flexibilizers are polyurethane modified epoxies sold under the tradenames GME-3210 and GME-3220, commercially available from GNS Technologies. From experimental results it has been observed that a polyurethane-modified epoxy flexibilizer is capable of improving impact strength (particularly as demonstrated by a wedge impact test) while at the same time having a minimal effect on the reduction of glass transition temperature. Yet further examples of preferred flexibilizer are amine or epoxy terminated polyethers such as JEFFAMINE D-2000, commercially available from Huntsman and DER 732, commercially available from the Dow Chemical Company. Flexibilizers based on cashew nutshell liquid such as the epoxidized liquids Cardolite NC-514 and Cardolite Lite 2513 HP are also useful flexibilizers. All of the individual flexibilizers discussed herein may be used separately or in combination with each other in the formulations of the present invention, unless otherwise stated.

The formulations may include a phenoxy resin component. Phenoxy resins are high molecular weight thermoplastic condensation products of bisphenol A and epichlorohydrin and their derivatives. Examples of suitable materials are the PKHB, PKHC, PKHH, PKHJ, PKHP pellets and powder. Alternatively, phenoxy/polyester hybrids and epoxy/phenoxy hybrids may be used.

The formulations may include one or more additional polymers or copolymers, which can include a variety of different polymers, such as thermoplastics, elastomers, plastomers combinations thereof or the like. For example, and without limitation, polymers that might be appropriately incorporated include halogenated polymers, polycarbonates, polyketones, urethanes, polyesters, silanes, sulfones, allyls, olefins, styrenes, silicones, phenolics, rubbers, polyphenylene oxides, terephthalates, acetates (e.g., EVA), acrylates, methacrylates (e.g., ethylene methyl acrylate polymer) or mixtures thereof. Other potential polymeric materials may be or may include, without limitation, polyolefin (e.g., polyethylene, polypropylene) polystyrene, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, and polymethacrylate.

One or more curing agents and/or curing agent accelerators may be added to the formulations. Amounts of curing agents and curing agent accelerators can vary widely within the formulations depending upon the type of cellular structure desired, the desired amount of expansion of the formulations, the desired rate of expansion, the desired structural properties of the formulations and the like. Exemplary ranges for the curing agents or curing agent accelerators present in the formulations range from about 0.001% by weight to about 7% by weight.

The formulations may also include one or more reinforcement components. Preferably the reinforcement components include a material that is generally non-reactive with the other components present in the formulations. It is contemplated that the reinforcement components may also impart properties such as strength and impact resistance to the formulations.

Examples of reinforcement components include wollastonite, silica, diatomaceous earth, glass, clay (e.g., including nanoclay), glass beads or bubbles, glass, carbon or ceramic fibers, nylon, aramid or polyamide fibers, and the like. The one or more reinforcement components may be selected from mineral reinforcements such as diatomaceous earth, clay (e.g., including nanoclay), pyrophyllite, sauconite, saponite, nontronite, wollastonite, or montmorillonite. The reinforcement component may include a silica and/or calcium mineral reinforcement. The reinforcement component may include glass, glass beads or bubbles, carbon or ceramic fibers, nylon, aramid or polyamide fibers (e.g., Kevlar). The reinforcement component may be wollastonite. The reinforcement component may be a fiber with an aspect ratio of from about 20:1 to about 3:1. The reinforcement component may be a fiber with an aspect ratio of from about 15:1 to about 10:1. The reinforcement component may be a fiber with an aspect ratio of about 12:1. It is possible that the reinforcement component improves a first physical characteristic while simultaneously substantially avoiding any significant detrimental effect on a second physical characteristic. As one example, the selected reinforcement component may improve the overall modulus of the material while still having minimal detrimental effect on strain to failure. The material may further include one or more fillers including pigments or colorants, calcium carbonate, talc, silicate minerals, vermiculite, mica, or the like.

When employed, the reinforcement components in the formulations can range from 10% or less to 90% or greater by weight of the formulations, but more typical from about 20% to 55% by weight of the formulations. According to some embodiments, the formulations may include from about 0% to about 30% by weight, and more preferably slightly less than 10% by weight reinforcement components.

Other additives, agents or performance modifiers may also be included in the formulations as desired, including but not limited to a UV resistant agent, a flame retardant, a polymeric particle, a heat stabilizer, a colorant, a processing aid, a lubricant or the like.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100.

The disclosures of all articles and references, including patent applications and publications, are incorporated by reference for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A method for forming the composition of claim 15 comprising:
combining the polycarbonate thermoplastic with the decomposition initiator to decompose the polycarbonate;
heating the polycarbonate thermoplastic and decomposition initiator to a temperature between 120° C. and 250° C. for the release of carbon dioxide;
wherein the polycarbonate thermoplastic and decomposition initiator are combined with the one or more additional components for forming a heat activated material that foams as a result of the release of carbon dioxide.

2. (canceled)

3. The method of claim 1, wherein the decomposition initiator is or comprises an amine; preferably selected from tertiary amines, imidazoles, amine adducts, triazoles and ammonium derivatives.

4. The method of claim 1, wherein the decomposition initiator is or comprises dicyandiamide, an urea functional group, a reaction product of bisphenol A epoxy and monoethanolamine, a metal carbonate, a blocked isocyanate, and ammonium salt, metal halide, a metal hydroxide, a metal triflate, a metal stearate, an organophilic phyllosilicate, a metal acetylacetonate, a titanate complex, a metal phosphate ester salt, a Lewis acid, or any combination thereof.

5-7. (canceled)

8. The method of claim 1, wherein the polycarbonate thermoplastic is dissolved in a suitable solvent to form a dissolution product.

9. The method of claim 8, wherein the solvent is or comprises liquid epoxy, solid epoxy, or a combination thereof.

10-11. (canceled)

12. The method of claim 8, wherein the solvent is or comprises a polycarbonate polyol.

13. The method of claim 8, wherein the solvent is or comprises a polycaprolactone polyol.

14. The method of claim 8, wherein the solvent is or comprises an organic solvent, including but not limited to acetone, methyl ethyl ketone, diethyl ketone, toluene or xylene.

15. A composition comprising:
a polycarbonate thermoplastic;
a decomposition initiator to decompose polycarbonate;
an optional solvent in which the polycarbonate is dissolved;
one or more additional components for forming a heat-activated adhesive;
wherein the polycarbonate thermoplastic and decomposition initiator are adapted to release carbon dioxide upon heating the composition to a temperature between 120° C. and 250° C.

16. (canceled)

17. The composition of claim 15, wherein the decomposition initiator is or comprises an amine preferably selected from tertiary amines, imidazoles, amine adducts, triazoles and ammonium derivatives.

18. The composition of claim 15, wherein the decomposition initiator is or comprises dicyandiamide, an urea functional group, a reaction product of bisphenol A epoxy and monoethanolamine, an ammonium salt, a blocked isocyanate, a metal carbonate, a metal halide, a metal hydroxide, a metal triflate, a metal stearate, a metal acetylacetonate, a titanate complex, a metal phosphate ester salt, a Lewis acid, or any combination thereof.

19-21. (canceled)

22. The composition of claim 18, wherein the polycarbonate is dissolved in a suitable solvent to form a dissolution product.

23. The composition of claim 22, wherein the solvent is or comprises liquid epoxy, a solid epoxy, or a combination thereof.

24-28. (canceled)

29. A composition comprising:
at least 10% by weight epoxy resin;
at least 0.5% by weight dicyandiamide;
at least 0.5% by weight substituted urea;
from about 2-15% by weight polycarbonate thermoplastic.

30. The composition of claim 29, wherein the weight ratio of dicyandiamide:compound bearing urea functional group, preferably substituted urea, is within the range of from 1:0.5 to 1:1.5.

31. The composition of claim 29, wherein the polycarbonate thermoplastic and the decomposition initiator are micro-pulverized.

32. The composition of claim 31, which additionally comprises another foaming agent; preferably a chemical foaming agent; more preferably selected from azodicarbonamide and benzenesulphonylhydrazide; still more preferably azodicarbonamide.

33. The composition of claim 31, which does not additionally comprise another foaming agent.

34. The composition of claim 29, which additionally includes one or more polymeric particles.

35-36. (canceled)

37. The composition of claim 29, which additionally includes one or more phenoxy resins.

38-41. (canceled)
